(19) United States
(12) Patent Application Publication
(10) Pub. No.: US 2025/0212923 A1
(43) Pub. Date: Jul. 3, 2025

(54) FLAVOUR DELIVERY SYSTEM

(71) Applicant: FLAVOUR PRODUCTS B.V., Wageningen (NL)

(72) Inventors: Herman DE RAAT, Wageningen (NL); Tjitze ROEPER, Wageningen (NL)

(73) Assignee: FLAVOUR PRODUCTS B.V., Wageningen (NL)

(21) Appl. No.: 18/853,157

(22) PCT Filed: Oct. 17, 2022
(86) PCT No.: PCT/EP2022/078824

§ 371 Date: Oct. 1, 2024

(30) Foreign Application Priority Data
Apr. 8, 2022 (EP) 22167478.1

(51) Int. Cl. A23L 27/00; A23D 7/005; A23D 7/04; A23J 3/22; A23L 27/20; A23L 27/22; A23L 27/23

(52) U.S. Cl. CPC A23L 27/80; A23D 7/0053; A23D 7/04; A23J 3/227; A23L 27/2024; A23L 27/22; A23L 27/235

(57) ABSTRACT

The present invention provides a solid or semi-solid flavour delivery system, comprising:
30-60 wt. % water;
10-40 wt. % fat;
8-40 wt. % of a starch component selected from starch, modified starch and combinations thereof; and
flavouring;
   wherein the flavour delivery system comprises, calculated by weight of the flavour delivery system, 0.1-20 mg/kg 2,4-heptadienal and 1-200 mg/kg 2,4-decadienal.

This flavour delivery system can be applied in foodstuffs such as meat analogues, processed meat and extruded products to provide a nice juicy, fatty flavour during consumption of the foodstuff.

### TECHNICAL FIELD OF THE INVENTION

The present invention relates to a solid or semi-solid flavour delivery system that comprises an oil-and-water emulsion containing a combination of water-soluble and fat-soluble flavour components. The flavour delivery system of the present invention may suitably be incorporated in e.g. meat analogues, to provide a pleasant juicy, meaty flavour that is released during chewing.

### BACKGROUND OF THE INVENTION

It is well recognised in the food industry that for many food products the use of flavourings is essential for achieving the desired palatability.

The application of flavourings in foodstuffs poses a formidable challenge as the impact of the flavouring on the perception of the foodstuff by a consumer is not only determined by the composition of the flavouring, but also by its release from the foodstuff prior to and during consumption. Since flavourings typically contain a multitude of flavour substances, ranging from water-soluble components to highly volatile lipophilic components, the release of the individual flavour substances is affected in different ways by the composition and structure of a foodstuff. Consequently, the composition of each flavouring must be tailored towards the foodstuff in which it is applied.

For some foodstuffs flavourings need to be provided in the form of a flavour delivery system that protects the flavouring during manufacture, distribution and storage of the foodstuff and provides a desired flavour release when the foodstuff is prepared or consumed.

Meat analogues are an example of a type of foodstuff that requires flavouring in order to render the product acceptable to consumers. The challenge of imparting a meat-like flavour to plant-based meat analogues, requires analysis and identification of the flavour compounds produced by e.g. Maillard reactions and lipid oxidation during the preparation of animal meat products. Once these compounds have been identified, they need to be included in suitable concentrations in the flavouring. In meat analogues, however, this approach does not lead to a satisfactory result as important components of the flavouring become irreversibly bound to plant-derived ingredients of the meat analogue during manufacture. In addition, it has as yet been impossible to mimic in meat analogues the juicy, fatty flavour that is observed during the consumption of prepared meat products.

The food industry has tried to overcome this shortcoming of meat analogues by increasing the oil and fat content of the food, resulting in a higher calorific value and in many cases leading to oil leakage during manufacture and food preparation.

US 2007/0298154 describes a flavoured solid-form food product that is easily dispersible in aqueous liquids comprising:
an edible fat;
a gelled, edible starchy material;
a flavouring agent;
a solidifying agent; and
an aqueous liquid.

US 2014/0161958 describes a method of preparing a meat substitute product, the method comprising:
a. preparing a mixture consisting essentially of:
   i. 40% to 60% water;
   ii. 15% to 35% of a vegetable lipid material;
   iii. 15% to 35% of at least one starch; and
   iv. 1% to 6% of a hydrocolloid;
b. heating the mixture to 73.9 to 76.7° C.;
c. cooling the heated mixture to provide a fat mimetic; and
d. combining a meat substitute and the fat mimetic to provide a meat substitute product.

US 2020/0037646 describes a flavour modifier composition for a meat analogue comprising: a yeast extract; a fatty acid; peptide material having a molecular weight of 300-10,000 Da; and at least two free amino acids wherein at least one free amino acid is a sulphur containing amino acid.

WO 2021/028376 describes a solid fat delivery system comprising emulsified plant-based fat at least partially encapsulated within a combination of a gelled potato starch and at least one hydrocolloid. The solid fat delivery system may be applied in plant-based meat analogues.

CN 111213870 relates to roasted chicken flavourings in the form of a paste. These roasted chicken flavourings contain 2,4-heptadienal and 2,4-decadienal.

WO 2011/000524 describes a particulate flavour delivery system comprising a starch carrier and a blend of a first flavouring agent and a plasticizer, said plasticizer being liquid at a temperature of 20-25″C.

WO 2022/037760 relates to a flavour composition comprising:
an amino acid component comprising three or more amino acids selected from the group consisting of ornithine, proline, aspartic acid, threonine, alanine, serine, histidine, arginine, glutamic acid, glycine, valine, and lysine;
an edible acid component comprising at least one edible acid selected from the group consisting of citric acid, and lactic acid.

### SUMMARY OF THE INVENTION

The present invention provides a solid or semi-solid flavour delivery system that can be applied in foodstuffs such as meat analogues, processed meat and extruded products to provide a nice juicy, fatty flavour during consumption of the foodstuff.

The solid or semi-solid flavour delivery system of the present invention comprises:
(a) 30-60 wt. % water;
(b) 10-40 wt. % fat;
(c) 8-40 wt. % of a starch component selected from starch, modified starch and combinations thereof; and
(d) flavouring;
   wherein the flavour delivery system comprises, calculated by weight of the flavour delivery system, 0.1-20 mg/kg 2,4-heptadienal and 1-200 mg/kg 2,4-decadienal.

The flavour delivery system of the present invention may suitably be distributed throughout foodstuffs in the form of small pieces. This may be achieved, for instance, by providing the flavour delivery system in particulate form and by mixing it with other food ingredients. During the preparation of foodstuffs, the flavour delivery system of the present invention effectively protects the flavour components contained therein. In the final foodstuff, the small pieces of flavour delivery system retain the flavouring components, thereby preventing interactions with other components of the foodstuff that adversely affects their flavour contribution.

Irreversible binding and degradation are examples of adverse effects that may result from such interactions.

When applied in foodstuffs, the flavour delivery system of the present invention not only retains the flavour components during storage of the foodstuff, but also when the foodstuff is prepared by cooking it. When the cooked foodstuff is consumed, the flavour components contained in the flavour delivery system are released.

The inventors have found that when the flavouring that is present in the flavour delivery system includes 2,4-heptadienal and 2,4-decadienal in the concentration levels mentioned above, the flavour delivery system imparts a very nice juicy, fatty flavour note to the foodstuff in which it is incorporated. Besides 2,4-heptadienal and 2,4-decadienal, the flavouring may suitably comprise other flavour substances so as to provide a complex rounded-off meat flavour.

Other aspects of the present invention relate to the use of the aforementioned flavour delivery system for flavouring foodstuffs and to foodstuffs comprising such a flavour delivery system.

The present invention further provides a process of preparing a flavour delivery system according to the present invention, the process comprising:
combining water, the one or more water-soluble components and the starch component to produce an aqueous slurry, said flavouring comprising 2,4-heptadienal and 2,4-decadienal;
combining the fat and the one or more oil-soluble flavouring compounds to produce a flavoured fat, and
mixing the aqueous slurry and the flavoured fat.

### DETAILED DESCRIPTION OF THE INVENTION

Accordingly, a first aspect of the invention relates to a solid or semi-solid flavour delivery system of the present invention comprises:
(a) 30-60 wt. % water;
(b) 10-40 wt. % fat;
(c) 8-40 wt. % of a starch component selected from starch, modified starch and combinations thereof; and
(d) flavouring;
   wherein the flavour delivery system comprises, calculated by weight of the flavour delivery system 0.1-20 mg/kg 2,4-heptadienal and 1-200 mg/kg 2,4-decadienal.

The term “fat” as used herein refers to glycerol fatty acid esters selected from triglycerides, diglycerides, monoglycerides and glycerophospholipids. Unless indicated otherwise, the terms “fat” and “oil” are used interchangeably.

The term “starch” as used herein refers to a non-modified starch and encompasses native as well pregelatinised starch.

The term “maltodextrin” refers to a partially hydrolysed starch having a DE (dextrose equivalent) between 3 and 20.

The term “modified starch” refers to a starch derivatives that have been obtained by etherification or esterification of one or more of the starch's hydroxyl groups. Examples of modified starches include acetylated starch, hydroxypropylated starch, hydroxyethylated starch, succinylated starch, carboxymethylated starch and combinations thereof.

The term “textured vegetable protein” or “TVP” as used herein refers to proteinaceous plant-based materials that have been processed to impart a meat-like texture. Examples of processing methods that may be utilized are extrusion (including high moisture extrusion [HME]) and fibre spinning.

Unless indicated otherwise, all percentages mentioned herein should be construed as weight percentages.

The flavour delivery system of the present invention may be provided in solid or semi-solid form. Preferably the flavour delivery system is a solid flavour delivery system, i.e. flavour delivery system that holds its shape.

In accordance with a preferred embodiment of the present invention, the combination of components (a) and (c) constitutes at least 50 wt. %, more preferably this combination constitutes 55-88 wt. % of the flavour delivery system.

The combination of components (a), (b) and (c) preferably constitutes at least 70 wt. %, more preferably at least 80 wt. % and most preferably 85-99.5 wt. % of the flavour delivery system.

The water content of the flavour delivery system is preferably in the range of 25 to 70 wt. %, more preferably in the range of 30 to 60 wt. % and most preferably in the range of 35 to 58 wt. %.

The flavour delivery system of the present invention preferably comprises 10-38 wt. %, more preferably 15 to 36 wt. % and most preferably 20 to 34 wt. % of the starch component.

Expressed differently, the flavour delivery system preferably contains 30-80% of starch component by weight of water, more preferably it contains 40-70% of starch component by weight of water.

The starch component preferably comprises a combination of native starch and modified starch. More preferably, the starch component is composed of 2 to 50 wt. % of native starch and 50 to 98 wt. % of modified starch. Most preferably, the starch component is composed of 5 to 30 wt. % of native starch and 70 to 95 wt. % of modified starch.

Modified starches that may suitably be employed in the flavour delivery system include hydroxypropylated starch (E1440), monostarch phosphate (E1410), distarch phosphate (E1412), hydroxypropyl distarch phosphate (E1442), starch sodium octenyl succinate (E1450), oxidized starch (E1404) and maltodextrin. Preferably, the flavour delivery system comprises hydroxypropyl distarch phosphate. According to a particularly preferred embodiment, the flavour delivery system contains, calculated by weight of the starch component, 30-95 wt. % of hydroxypropyl distarch phosphate.

According to preferred embodiment, the flavour delivery system contains 0.1-10 wt. %, more preferably 0.5-5 wt. % of a polysaccharide component selected from carrageenan, alginate, pectin, gellan gum, agar, galactomannan, xanthan gum, gum arabic, karaya gum, gum ghatti, konjac gum, carob gum, microfibrillated cellulose, carboxymethyl cellulose, curdlan, methyl cellulose and combinations thereof. Examples of galactomannans that may be employed include fenugreek gum, guar gum, tara gum, locust been gum, cassia gum and combinations thereof.

According to a particularly preferred embodiment, the flavour delivery system comprises 1-3 wt. % of a hydrocolloid selected from carrageenan, locust bean gum, methylcellulose and combinations thereof.

The fat content of the flavour delivery system is preferably in the range of 12 to 36 wt. %, more preferably in the range of 15 to 32 wt. % and most preferably in the range of 17 to 30 wt. %.

Preferably, the fat that is contained in the flavour delivery system contains at least 70 wt. %, more preferably at least 80 wt. % and most preferably at least 90 wt. % of triglycerides.

The fat that is contained in the flavour delivery system of the present invention may be liquid or solid at ambient temperature. Preferably, the fat has a solid fat content at 15° C. (N₁₅) of at least 20%, more preferably of 30-80% as determined by pulsed NMR using ISO 8292-2:2008.

The concentration of 2,4-heptadienal in the flavour delivery system of the present invention preferably is in the range of 0.2-15 mg/kg, more preferably in the range of 0.3-10 mg/kg and most preferably in the range of 0.5-8 mg/kg. Here the term “2,4-heptadienal” encompasses all cis-trans isomers of the aldehyde.

Preferably, the 2,4-heptadienal that is employed in accordance with the present invention includes (E,E)-2,4-heptadienal. According to a particularly preferred embodiment, the flavour delivery system contains at least 0.2 mg/kg, more preferably at least 0.3 mg/kg and most preferably at least 0.4 mg/kg (E,E)-2,4-heptadienal.

The concentration of 2,4-decadienal in the flavour delivery system of the present invention preferably is in the range of 2-180 mg/kg, more preferably in the range of 3-160 mg/kg and most preferably in the range of 4-150 mg/kg. Here the term “2,4-decadienal” encompasses all cis-trans isomers of the aldehyde.

Preferably, the 2,4-decadienal that is employed in accordance with the present invention includes (E,E)-2,4-decadienal. According to a particularly preferred embodiment, the flavour delivery system contains at least 2 mg/kg, more preferably at least 3 mg/kg and most preferably at least 4 mg/kg (E,E)-2,4-decadienal.

The aldehydes 2,4-heptadienal and 2,4-decadienal are preferably present in the flavour delivery system of the present invention in a weight ratio of 1:5 to 1:100, more preferably in a weight ratio of 1:8 to 1:80 and most preferably in a weight ratio of 1:10 to 1:60.

The inventors have found that when the aforementioned aldehydes are present in the flavour delivery system, the flavour delivery system imparts a juicy, fatty flavour note to the foodstuff in which it is incorporated. The quality of this particular flavour note may be further improved by including one or additional flavour substances such as (E,E)-2,4-undecadienal, acetoin, delta-decalactone, delta-dodecalactone, oleic acid, linoleic acid.

(E,E)-2,4-undecadienal is preferably present in the flavour deliver system in a concentration of 0.2-30 mg/kg, more preferably in a concentration of 1-20 mg/kg.

Acetoin is preferably present in the flavour deliver system in a concentration of 1 to 140 mg/kg, more preferably in a concentration of 3 to 80 mg/kg.

Lactones selected from delta-decalactone, delta-dodecalactone and combinations thereof are preferably present in the flavour deliver system in a concentration of 0.1 to 75 mg/kg, more preferably in a concentration of 0.2 to 10 mg/kg.

Unsaturated fatty acids selected from oleic acid, linoleic acid and combinations thereof are preferably present in the flavour deliver system in a concentration of 80-10,000 mg/kg, more preferably in a concentration of 120-4,000 mg/kg.

In order to provide a rounded-off complex juicy, meaty flavour, the flavour delivery system preferably contains other flavour components, besides those contributing to the juicy fatty flavour, said other components providing meaty flavour notes. Such additional flavour components may include fat-soluble volatile flavour substances as well as water-soluble essentially non-volatile flavour substances.

Water-soluble components that may suitably be incorporated in the flavour delivery system include flavour components that are capable of imparting an umami taste or that can enhance umami taste, notably glutamate, IMP and GMP. The water-soluble components can also include Maillard precursor components in the form of free amino acids such as cysteine and methionine and reducing sugars such as galactose, glucose, glyceraldehyde, fructose, ribose, xylose and maltose.

According to a preferred embodiment, the flavour delivery system comprises 0.01-10 wt. %, more preferably 0.02 to 4 wt. % and most preferably 0.1 to 2 wt. % of one or more water-soluble components selected from free amino acids, small peptides having a molecular weight of not more than 400Da, inosine-5′-monophosphate (IMP), guanosine-5′-monophosphate (GMP) and reducing sugar.

In accordance with a preferred embodiment, the flavour delivery system comprises at least 0.01 wt. %, more preferably at least 0.1 wt. % of one or more water-soluble flavour compounds selected from glutamate, inosine-5′-monophosphate (IMP) and guanosine-5′-monophosphate (GMP).

In accordance with a further advantageous embodiment, the flavour delivery system comprises 0.1-2 wt. % of one or water-soluble amino acids selected from cysteine, methionine and thiamine combinations thereof and 0.1-1 wt. % of one or more reducing sugars selected from galactose, glucose, glyceraldehyde, fructose, ribose, xylose, maltose and combinations thereof.

In a particularly preferred embodiment of the invention, the flavour delivery system comprises one or more flavour substances that contribute meaty flavour notes. Accordingly, the flavour delivery system preferably contains 1-10,000 mg/kg, more preferably 2-2,000 mg/kg wt. % and most preferably 3-1,000 mg/kg of one or more fat-soluble flavour compounds selected from octanal, nonanal, methanethiol, methional, 2-furfurylthiol, 2-methyl-3-furanthiol, 3-mercapto-2-pentanone and 4-hydroxy-2,5-dimethyl-3-(2H)-furanone.

According to a particularly preferred embodiment, the flavour delivery system of the present invention comprises 10-1,000 mg/kg of a combination of three or more fat-soluble flavour compounds selected from octanal, nonanal, methanethiol, methional, 2-furfurylthiol, 2-methyl-3-furanthiol, 3-mercapto-2-pentanone and 4-hydroxy-2,5-dimethyl-3-(2H)-furanone.

Preferably, the flavour delivery system comprises 1-500 mg/kg, more preferably 20-300 mg/kg of one or more furanones selected from 4-hydroxy-2,5-dimethyl-3-(2H)-furanone (furaneol), 4-acetoxy-2,5-dimethyl-3 (2H)-furanone (furaneol acetate), 3-hydroxy-4,5-dimethylfuran-2 (5H)-one, 5-ethyl-3-hydroxy-4-methyl-2 (5H)-furanone,.

Preferably, the flavour delivery system comprises 0.1-100 mg/kg, more preferably 0.3-50 mg/kg of one or more sulphur compounds selected from methanethiol, methional, 2-furfurylthiol (FEMA 2493), 2,3-mercapto-2-pentanone, methyl-2-methyl-3-furyldisulfide, 2,4,6-tris(2-methylpropyl)-1,3,5-dithiazinane (FEMA 2400) and 2-methyl-3-methyldisulfanylfuran (FEMA 3573), methyl-3-furanthiol (FEMA 3787), 2-methyl-2,3-dihydrofuran-4-thiol (FEMA 4683), 2′,3a-dimethylspiro[6,6a-dihydro-5H-[1,3]dithiolo[4,5-b]furan-2,3′-oxolane] (FEMA 3270) and combinations thereof.

Preferably, the flavour delivery system comprises 0.1-30 mg/kg, more preferably 0.2-10 mg/kg of one or more pyrazines selected from 2-ethyl-3-methylpyrazine (FEMA 3155), 2-ethyl-3,5-dimethyl pyrazine, 2,3-diethyl-5-methylpyrazine and 2-methyl pyrazine.

According to a particularly preferred embodiment, the flavour delivery system comprises a dispersed fat phase having a volume weighted mean diameter D[4,3] of 3 to 800 μm, more preferably a volume weighted mean diameter D[4,3] of 10 to 500 μm.

The flavour delivery system of the present invention may be provided in different form, e.g. in the form of a block or a collection of pieces or particles. In a preferably embodiment, the flavour delivery system is provided in a particulate form, more preferably in the form of a collection of pieces or particles having a volume weighted mean diameter D[4,3] of 0.1-30 mm.

Another aspect of the present invention relates to the use of the flavour delivery system as described herein before for flavouring a foodstuff or for flavouring textured vegetable protein (TVP). Preferably, the foodstuff is a meat analogue, more preferably a meat analogue that contains textured vegetable protein (TVP) and/or high moisture extrusion (HME) vegetable protein.

A further aspect of the invention relates to a method of preparing a foodstuff or TVP, said method comprising mixing the flavour delivery system of the present invention with one or more other food ingredients.

According to a particularly preferred embodiment, the method of preparing a foodstuff or TVP comprises mixing the flavour delivery system with one or more food ingredients in an extruder. According to a particularly preferred embodiment, the mixture of the flavour delivery system and one or more food ingredients that is expelled from the extruder has a total fat content of less 8 wt. %, more preferably of less than 5 wt. %.

In a particularly advantageous embodiment, the flavour delivery system and the one or more food ingredients are mixed by means of high moisture extrusion (HME). Typically, during HME the mixture of the flavour delivery system and the one or more ingredients reaches a temperature of more than 120° C., more preferably a temperature of 130-170° C.

Surprisingly, the flavour delivery system of the present invention prevents the flavour components contained therein from becoming bound to protein even when the flavour delivery system is mixed with proteinaceous ingredients in an extruder under extreme conditions. Thus, the invention enables the preparation of, for instance, TVP or chunks of meat analogue having a juicy, fatty flavour, by mixing the flavour delivery system with a vegetable protein concentrate or a vegetable protein isolate in an extruder, preferably by means of high moisture extrusion. The invention also enables the preparation of meat analogues having such a juicy, fatty flavour, by mixing the flavour delivery system with TVP in an extruder.

Another aspect of the invention relates to a foodstuff or TVP comprising a flavour delivery system according to the present invention. Examples of foodstuffs in which the flavour delivery system of the present invention may suitably be applied include meat analogues, processed meat and extruded food products. Preferably, the foodstuff is a meat analogue, more preferably a meat analogue that contains textured vegetable protein (TVP).

The foodstuff of the present invention preferably contains 0.5-6 wt %, more preferably 1-5 wt. % of the flavour delivery system.

The flavour delivery system is preferably present in the foodstuff in the form of small pieces that homogeneously distributed throughout the foodstuff. Preferably, these small pieces of flavour delivery system have a volume weighted average diameter of 0.05 to 10 mm, more preferably of 0.1 to 1 mm.

Yet another aspect of the present invention relates to a process of preparing a flavour delivery system according to the present invention, the process comprising:
combining water, flavouring, fat and the starch component to produce an emulsion, said flavouring comprising 2,4-heptadienal and 2,4-decadienal;
heating the emulsion to a temperature of at least 60° C.;
introducing the emulsion into a container while the emulsion is still pourable; and.
allowing the emulsion in the container to cool down to a temperature of less than 35° C.

The invention is further illustrated by the following non-limiting examples.

### EXAMPLES

### Example 1

A flavour delivery system according to the present invention was prepared on the basis of the recipe that is shown in Table 1.

TABLE 1

| | Wt. % |
|---|---|
| Starch blend ¹ | 28.2 |
| Carrageenan (iota) | 0.1 |
| Juicy fat flavouring | 0.7 |
| Beef flavouring | 0.14 |
| Mono-sodium glutamate | 0.5 |
| IMP and GMP | 0.05 |
| Yeast extract | 0.3 |
| Fat (coconut oil) | 23.4 |
| Water | 46.61 |

¹ Blend of hydroxypropyl di-starch phosphate (E1442), oxidized starch (E1404), starch sodium octenyl succinate (E1450) and native potato starch (weight ratio: 40:20:25:15)

The compositions of the juicy fat flavouring and the beef flavouring are shown in Tables 2 and 3, respectively.

TABLE 2

| | Parts by |
|---|---|
| | weight |
| (E,E)-2,4-heptadienal | 0.8 |
| (E,E)-2,4-decadienal | 10 |
| (E,E)-2,4-undecadienal | 0.5 |
| Acetoin | 3 |
| Delta-decalactone | 0.4 |
| Delta-dodecalactone | 0.2 |
| Oleic acid | 100 |
| Linoleic acid | 100 |
| Hexanoic acid | 20 |
| (E,E)-2,4-nonadienal | 1 |
| Triacetin | 760 |

TABLE 3

| | Parts by |
|---|---|
| | weight |
| Furaneol | 100 |
| Acetoin | 30 |
| 2-Methyl-3-tetrahydro-furanthiol | 0.2 |
| 2-Methyl-3-furanthiol | 0.5 |
| 2,3,5-Trimethyl pyrazine | 0.5 |
| Furfuryl mercaptan | 0.1 |
| Acetic acid | 1 |
| 2-methyl-4,5-dihydrofuran thiol | 0.5 |
| Furaneol acetate | 10 |
| Butyric acid | 0.2 |
| Fat (Miglyol 812 N) | 950 |

The flavour delivery system was prepared by first mixing the starch blend, the flavouring and the water. Next, the molten fat was added under vigorous stirring with a high shear mixer and the mixture was heated to 80° C. under continuous stirring. The hot mixture was poured into a plastic container that was left to cool to room temperature.

### Example 2

Flavoured meat analogues were prepared on the basis of the recipes shown in Table 4.

TABLE 4

Wt. %

| | 1 | A |
|---|---|---|
| Hydrated, textured rice flakes ¹ | 88.2 | 88.2 |
| Vegan food binder ¹ | 3.2 | 3.2 |
| Flavour delivery system of Example 1 | 3.5 | |
| Starch blend (same as in Example 1) | | 0.99 |
| Flavouring (same as in Example 1) | | 0.05 |
| Fat (same as in Example 1) | | 0.82 |
| Water | 5.3 | 6.94 |

¹ ex Meatless, the Netherlands

The meat analogues were prepared by mixing the textured rice flakes with water and the vegan food binder. Meat analogue 1 was prepared by adding the flavour delivery system to this followed by mixing in a Stephan cutter. The dough so obtained was transferred to a forming machine and stamped into a filet-type of meat analogue.

Meat analogue A was prepared in the same way as meat analogue 1 except that instead of the flavour delivery system, the starch blend, flavouring and fat were added.

After 3 days of refrigerated storage, the meat analogues 1 and A were evaluated by an expert panel after pan frying.

The panel found that there was hardly any noticeable juiciness and meaty flavour present in meat analogue A, whereas meat analogue 1 was found to have a nice juicy, meaty flavour.

### Example 3

Flavoured meat analogues were prepared on the basis of the recipes shown in Table 5.

TABLE 5

Wt. %

| | 1 | A |
|---|---|---|
| Textured rice flakes ¹ | 88.2 | 88.2 |
| Vegan food binder ¹ | 3.2 | 3.2 |
| Flavour delivery system of Example 1 | 3.5 | |
| Delivery system without flavour ² | | 3.5 |
| Water | 5.3 | 5.3 |

¹ ex Meatless, the Netherlands
² Prepared in the same way as the flavour delivery system of Example 1, but without addition of flavouring

The meat analogues were prepared by mixing the textured rice flakes with water and the vegan food binder, followed by addition of the delivery system and mixing in a Stephan cutter. The dough so obtained was transferred to a forming machine and stamped into a hamburger shaped meat analogue.

After 3 days of refrigerated storage, the meat analogues 1 and A were evaluated by an expert panel after pan frying.

The panel found that there was no juiciness and meaty flavour present in meat analogue A, whereas a juicy, meaty flavour was clearly noticeable in meat analogue 1.

### Example 4

Textured soy protein was prepared using a high moisture extrusion process on pilot plant scale (Thermofisher).

A mixture of soy protein concentrate and the flavour delivery system of Example 1 (4% by weight of soy protein concentrate) was fed into the extruder and water was injected into the extruder. The mixture was transported through the extruder, heated to a temperature of approximately 140° C. and expelled through a die in the form of a strand that was cut into pieces. The TVP so obtained had a moisture content of about 70% and were found to have a juicy, meaty taste.

### Example 5

A commercially available hamburger from the supermarket was tested in a consumer panel with 60 respondents against the same hamburger, but now with the flavour delivery system mixed into it (7 wt. %). The overall liking increased by 100% and the juiciness perception increased by 147%.

### Example 6

A flavour delivery system providing juicy, chicken meat flavour was prepared in the same way as in Example 1, except, that the beef flavouring was replaced by a chicken flavouring. The composition of the chicken flavouring is shown in Table 6.

TABLE 6

| | mg/kg |
|---|---|
| (E,E)-2,4-decadienal | 10 |
| (E,E)-2,4-heptadienal | 2 |
| 2-Methyl-3-furanthiol | 0.5 |
| 2-Methyl-3-tetrahydro-furanthiol | 5 |
| Bis-(2-methyl-3-furyl)-disulfide | 2 |
| Furaneol | 100 |
| Decanoic acid | 10 |
| Delta-decalacton | 2.5 |
| Sulfurol (2-(4-methyl-1,3-thiazol-5-yl)ethanol) | 4 |
| Furfuryl mercaptan | 0.5 |
| Triacetin | 863.5 |

### Example 7

A flavour delivery system providing juicy, fish flavour was prepared in the same way as in Example 1, using a single fish flavouring comprising fatty flavour notes instead of the combination of beef flavouring and fatty flavouring. The composition of the fish flavouring is shown in Table 7.

TABLE 7

| | mg/kg |
|---|---|
| Vanillin | 20 |
| Dimethyl sulfide | 1 |
| Trimethylamine 25% | 15 |
| Furaneol | 10 |
| Furaneol acetate | 10 |
| (E,E)-2,4-heptadienal | 0.1 |
| (E,E)-2,4-decadienal | 1 |
| Oleic acid | 20 |
| Acetoin | 0.8 |
| 2-Methyl-3-furanthiol | 0.5 |
| 2,3,5 Trimethyl pyrazine | 3 |
| Butyric acid | 15 |
| L-Carvone | 1 |
| Triacetin | 902.6 |

### Example 8

Textured soy protein was prepared using a low moisture extrusion process.

A mixture of soy protein concentrate and the flavour delivery system of Example 1 (4% by weight of soy protein concentrate) was fed into the extruder and water was injected into the extruder. The mixture was transported through the extruder, heated to a temperature of approximately 150° C. and expelled through a die in the form of a strand that was cut into pieces. The TVP pieces had a moisture content of about 15%. Next, the TVP pieces were dried to reduce the a water content of less than 10 wt. %.

After rehydration of the textured TVP soy protein pieces so obtained, these were found to have a juicy, meaty savoury taste.

1. A solid or semi-solid flavour delivery system comprising:
(a) 30-60 wt. % water;
(b) 10-40 wt. % fat;
(c) 8-40 wt. % of a starch component selected from starch, modified starch and combinations thereof; and
(d) flavouring;
wherein the flavour delivery system comprises, calculated by weight of the flavour delivery system, 0.1-20 mg/kg 2,4-heptadienal and 1-200 mg/kg 2,4-decadienal.

2. The flavour delivery system according to claim 1, wherein the combination of components (a), (b) and (c) constitutes at least 70 wt. % of the flavour delivery system.

3. The flavour delivery system according to claim 1, wherein the flavour delivery system contains 30-80% of the starch component by weight of water.

4. The flavour delivery system according to claim 1, wherein the fat has a solid fat content at 15° C. (N₁₅) of at least 20%.

5. The flavour delivery systems according to claim 1, wherein the concentration of 2,4-heptadienal is in the range of 0.2-15 mg/kg, preferably in the range of 0.3-10 mg/kg.

6. The flavour delivery system according to claim 1, wherein the flavour delivery system contains at least 0.2 mg/kg, preferably at least 0.3 mg/kg of (E,E)-2,4-heptadienal.

7. The flavour delivery system according to claim 1, wherein the concentration of 2,4-decadienal is in the range of 2-180 mg/kg, preferably in the range of 3-160 mg/kg.

8. The flavour delivery system according to claim 1, wherein the flavour delivery system contains at least 2 mg/kg, more preferably at least 3 mg/kg of (E,E)-2,4-decadienal.

9. The flavour delivery system according to claim 1, wherein the aldehydes 2,4-heptadienal and 2,4-decadienal are present in the flavour delivery system in a weight ratio of 1:5 to 1:100, preferably in a weight ratio of 1:8 to 1:80.

10. The flavour delivery system according to claim 1, wherein the flavour delivery system comprises at least 0.1 wt. % of one or more water-soluble flavour compounds selected from glutamate, inosine-5′-monophosphate (IMP) and guanosine-5′-monophosphate (GMP).

11. The flavour delivery system according to claim 1, wherein the flavour delivery system comprises a dispersed fat phase having a volume weighted mean diameter D[4,3] of 3 to 800 μm.

12. A method of preparing a foodstuff or textured vegetable protein, said method comprising mixing a flavour delivery system with one or more other food ingredients, wherein the flavour delivery system comprises 30-60 wt. % water, 10-40 wt. % fat, 8-40 wt. % of a starch component selected from starch, modified starch and combinations thereof, wherein the flavour delivery system comprises, calculated by weight of the flavour delivery system, 0.1-20 mg/kg 2,4-heptadienal and 1-200 mg/kg 2,4-decadienal.

13. The method according to claim 12, wherein the method comprises mixing the flavour delivery system with one or more food ingredients in an extruder.

14. The flavour delivery system according to claim 1, wherein the flavour delivery system forms at least part of a foodstuff or textured vegetable protein.

15. A process of preparing a flavour delivery system according to claim 1, the process comprising:
combining water, flavouring, fat and the starch component to produce an emulsion, said flavouring comprising 2,4-heptadienal and 2,4-decadienal;
heating the emulsion to a temperature of at least 60° C.; and
introducing the emulsion into a container while the emulsion is still pourable; and
allowing the emulsion in the container to cool down to a temperature of less than 35° C.
